(19) United States
(12) Patent Application Publication
(10) Pub. No.: US 2026/0300860 A1
(43) Pub. Date: Oct. 1, 2026

(54) DYNAMIC OPTIMIZATION FRAMEWORK FOR SEAMLESS NEW PRODUCT INTEGRATION (NPI) MANAGEMENT LEVERAGING PARTICLE SWARM OPTIMIZATION

(71) Applicant: Bank of America Corporation, Charlotte, NC (US)

(72) Inventors: Rinki Bhatia, Faridabad (IN); Avinash Basavant Nigudkar, Mumbai (IN); Lingaraj Gopalakrishnan, Chennai (IN); Vijay Battiprolu, Hyderabad (IN)

(21) Appl. No.: 19/092,101

(22) Filed: Mar. 27, 2025

(51) Int. Cl. G06Q 10/0631; G06N 3/006

(52) U.S. Cl. CPC G06Q 10/06312; G06N 3/006; G06Q 10/063114

(57) ABSTRACT

A method for new product integration (NPI) management by leveraging particle swarm optimization (PSO) is provided. The new product relates to a document processing product. The method includes initializing particles with random combinations of artificial intelligence (AI) model settings. Each of the plurality of particles represents a solution to a dynamic optimization problem. The problem addresses finding a current optimal particle for the AI model settings. The method evaluates a fitness function for each of the particles. The fitness function may be based on a document processing speed. The method includes updating a Pbest variable (Particle/local best) for a first particle when the document processing speed for the first particle is increased. The method includes updating a Gbest (Global best) for a second particle when the document processing speed is increased, and then refining the AI model settings based on the updating the Pbest and the Gbest.

### FIELD OF THE DISCLOSURE

Aspects of this disclosure relate to new product integration (NPI) management.

### BACKGROUND OF THE DISCLOSURE

Integrating any new product in corporate organizations faces numerous challenges as follow.

Inefficiencies associated with NPI include the fact that existing management process lacks structure for processing NPIs. The lack of structure leads to increased security risks, resource consumption overruns, schedule delays, and supply chain disruptions.

There is also a lack of proactive management measures. The lack of proactive management measures increases vulnerability to security breaches and compliance issues.

Resource allocation associated with NPI is complex and often suboptimal. Such resource allocation deficiencies cause bottlenecks and inefficiencies in project execution.

Often, a lack of real time monitoring of NPI exists. The absence of real-time monitoring and adaptive capabilities hampers the entity's ability to respond swiftly to changing conditions and mitigate potential challenges.

### SUMMARY OF THE DISCLOSURE

To address these challenges, comprehensive and innovative solutions are provided that leverage Particle Swarm Optimization (PSO). These solutions may also involve other cutting-edge technologies such as artificial intelligence (AI), Internet of Things (IoT), Blockchain, Edge Computing, Cybersecurity, and more. For the purposes of this application PSO should be understood to refer to a computational optimization technique. This technique utilizes computer technology to mimic the behavior of bird flocks or fish schools. In such techniques, the population of “particles” (solutions) move through a search space. As they move, the particles adjust their movement based on their own best previous position and the best position found by the entire swarm. The aim of the group is to converge, preferably using software or hardware agents, toward an optimal solution to a given problem.

In the context of Particle Swarm Optimization (PSO), a particle represents a potential, or actual, solution to an optimization problem. Each particle is essentially a data point in the search space, characterized by:
Position—The current state or value of the solution;
Velocity—The rate at which the particle moves toward an optimal solution; and
Fitness Value—A value representing how good the particle's current position is in relation to the optimization goal (e.g., minimizing resource consumption, maximizing performance).

In a PSO-based framework, particles collectively explore the search space to find the optimal solution by adjusting their positions and velocities based on:

The particle's own experience (local best solution); and

The collective experience of the swarm of particles (global best solution).

One exemplary use case scenario relates to an entity launching a new AI-based document—e.g., consumer loan, credit card application, online banking platform—processing platform.

Objective: The goal is to minimize document processing time while maximizing accuracy and compliance of information set forth in the document.

In this scenario, the particles may represent, and include parameters relating to, the following:

different AI model configurations (e.g., neural network depth, learning rate);
different fraud detection thresholds; and
different blockchain consensus mechanisms.

The PSO process, according to an exemplary embodiment, preferably operates as follows:
Initialization:
   Particles may be initialized with random combinations of AI model settings, fraud detection thresholds, and compliance strategies.
Evaluation:
   Fitness function evaluates based on:
   Document processing speed;
   Fraud detection accuracy; and
   Compliance score.
Update:
   Particle 1 updates its Pbest (Particle/local best) after improving fraud detection accuracy.
   Particle 2 updates its Gbest (Global best) after improving document processing speed by adjusting an AI learning rate.
   The process is repeated with other particles assigned with specific evaluation tasks.
Convergence:

After 100, or some other suitable, preferably pre-determined number of, iterations, the PSO engine converges to an optimal setting where document processing time is reduced, if not minimized, fraud detection accuracy is increased, if not maximized, and a compliance score meets regulatory standards.

Benefits of such an approach include an increase in exploration and exploitation of various solutions. Particles ensure a balanced search across the solution space—avoiding local minima and preferably achieving a global optimum.

Benefits also include adaptability. Particles dynamically adapt to real-time changes (e.g., traffic spikes, regulatory updates).

Benefits further include autonomous optimization. As such, there is preferably no need for manual tuning. Rather, the PSO automates the adjustment process through particle updates.

And the benefits include scalability. Thus, as the NPI complexity grows, the number of particles and their search dimensions can scale.

Also included in the benefits are parallel processing. As such, particles operate concurrently, increasing the efficiency of the solution search process.

Solutions according to the embodiments may involve the following:
1. PSO-driven Governance Framework:

Implementing a PSO-driven challenge governance framework enables proactive identification, assessment, and mitigation of challenges throughout the NPI process. Preferably, the PSO dynamically optimizes management parameters to minimize potential security threats and ensure compliance.
2. Real-time Resource Allocation Optimization:

Integrating PSO with AI facilitates predictive resource needs analysis. Predictive resource needs analysis preferably enables optimal allocation of resources to minimize bottlenecks and maximize efficiency during NPI. PSO may dynamically adjust resource allocation parameters based on real-time data and predictive analytics.
3. Dynamic Schedule Optimization:

PSO integration with IoT provides real-time project performance data. Real-time project performance data enables dynamic adjustments to schedules based on real-time reports of actual progress and emerging challenges. PSO monitors and optimizes scheduling parameters to ensure timely delivery of an online entity-access platform.
4. Enhanced Security and Compliance:

Leveraging PSO Integration with cybersecurity solutions and threat intelligence ensures proactive identification and mitigation of potential security risks. In some embodiments, PSO can dynamically adjust security parameters to address emerging threats and maintain compliance with regulatory standards.

A system according to the embodiments set forth herein provides new product integration (NPI) management by leveraging particle swarm optimization (PSO). The NPI management can relate to a new product that involves document processing.

Such a system may include a processor. The processor may, in certain embodiments, initialize a plurality of particles with random combinations of artificial intelligence (AI) model settings. Each of the plurality of particles represents a solution to a dynamic optimization problem. The dynamic optimization problem addresses finding a current optimal particle for the AI model settings.

The processor may be used for evaluating a fitness function for each of the particles. The fitness function may be based, at least in part, on a document processing speed.

The processor is operable to update a Pbest (Particle/local best) for a first particle when the document processing speed is increased by adjusting an AI learning rate for the first particle. The processor may be further operable to update a Gbest (Global best) for a second particle when the document processing speed is increased.

Each of the random combinations of AI settings may include one or more of a fraud detection threshold, a document compliance strategy, and a blockchain consensus mechanism. The blockchain mechanism may be used to store some or all of the particle information, AI model information, AI model settings or any of the other suitable values described herein.

The blockchain mechanism preferably stores the aforementioned information. In some embodiments, in order to maintain relevant information on the blockchain and to preserve storage on the blockchain mechanism, some embodiments may involve a first-in, first-out arrangement on the blockchain mechanism in order to maintain a pre-determined level of relevant information in the blockchain. Such an arrangement may preferably reduce the memory of the blockchain mechanism as well as the bandwidth to and from the blockchain mechanism.

In some embodiments, the Gbest of one or more of the particles may be increased by adjusting an AI learning rate.

In certain embodiments, the processor may be operable, following a pre-determined number of iterations, to converge to an optimal setting where the document processing time is reduced, if not minimized, a fraud detection accuracy is increased, if not maximized, and/or a compliance score meets pre-determined regulatory standards.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an illustrative flow diagram in accordance with the principles of the disclosure;

FIG. 4 shows another illustrative flow diagram in accordance with the principles of the disclosure; and

FIG. 5 shows an illustrative interactive graphical user interface (“GUI”) in accordance with the principles of the disclosure.

### DETAILED DESCRIPTION OF THE DISCLOSURE

AI-Driven Consumer Behavior Insights: The integration of AI-NLP with PSO for predictive budget analysis, offers nuanced insights into consumer behavior and market trends for more accurate budget estimations.
Tamper-resistant transaction records: such records, according to the disclosure, provide security measures that involve integrating AI-NLP with PSO to ensure a substantially immutable record of activities. These records ensure the existence of a tamper-resistant foundation for transaction security.
Continuous Blockchain Vigilance: The continuous monitoring of blockchain facilitated by integration with threat intelligence, ensuring persistent vigilance against potential threats and immediate security responses.
Seamless Edge Computing Integration: The integration of Edge Computing with PSO, ensuring efficient real-time data processing without integration issues, contributing to seamless interoperability during NPI.

The following features evoke the surprising technological achievements of the embodiments.
Real-time Updates from integrated Modules: The inclusion of real-time updates from modules like AI (NLP), Blockchain, Edge Computing, IoT, and Cybersecurity emphasizes the continuous monitoring and responsiveness of the system to changing conditions.
Dynamic Parameter Adjustment by PSO: The specific use of Particle Swarm Optimization (PSO) for dynamically adjusting parameters implements a unique optimization technique for enhancing the efficiency of each module in response to real-time updates.
Centralized Optimization Hub: The presence of the optimization hub as a central coordinating entity underscores a centralized and organized approach to managing the flow of information and activities during the NPI process.
User Input and Trigger: User initiates the NPI process through the UI, triggering a coordination signal sent to the optimization hub.
Coordination Signal to Integrated Modules: Optimization Hub sends a coordination signal to all integrated modules, signaling the initiation of the NPI process.
Real-time Updates from Integrated Modules: Modules such as AI (NLP), Blockchain, Edge Computing, IoT, and Cybersecurity provide real-time updates on their respective operations.
Dynamic Parameter Optimization by PSO: PSO module receives real-time updates and adjusts parameters dynamically for each module based on its specific requirements.
Optimized Parameters to Integrated Modules: PSO sends the optimized parameters back to the integrated modules, ensuring efficient operation based on dynamic adjustments.
Visualizations on UI: UI receives real-time updates, alerts, and system status, displaying visualizations for user monitoring and interaction.
Efficient Data Flow between Modules: Optimized parameters flow efficiently between integrated modules, ensuring synchronized communication and data exchange.
Proactive Risk Management and Compliance Monitoring: Real-time updates and optimized parameters enable proactive security risk management, continuous compliance monitoring, and efficient resource utilization across the integrated modules.

In view of the foregoing, it is evident that this workflow ensures a dynamic and adaptive approach to NPI management.

As such, the PSO framework facilitates continuous adaptation, optimizing parameters for each module in response to real-time updates. Efficient communication and coordination among the integrated modules contribute to proactive security risk management, compliance monitoring, and overall efficiency in resource utilization throughout the NPI process.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

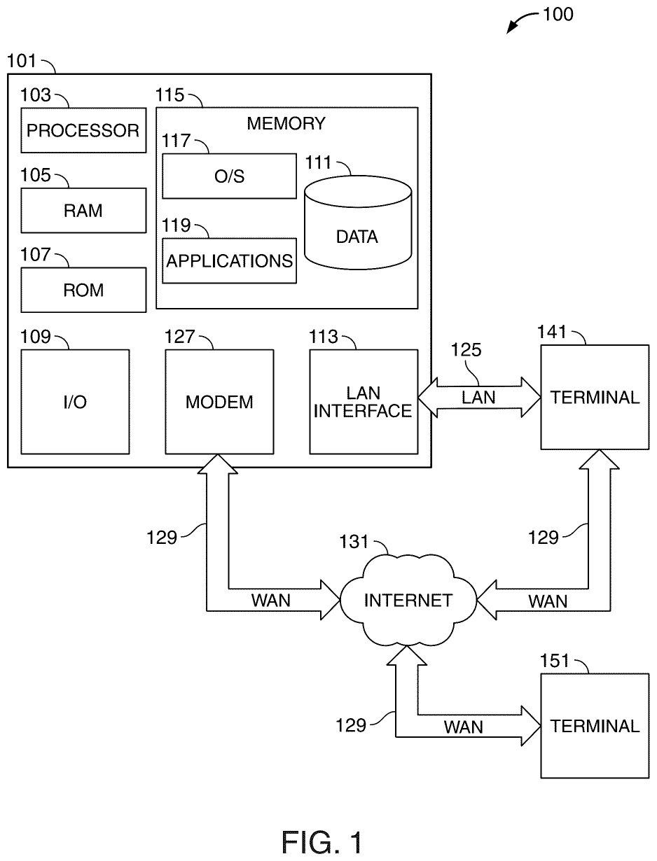

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

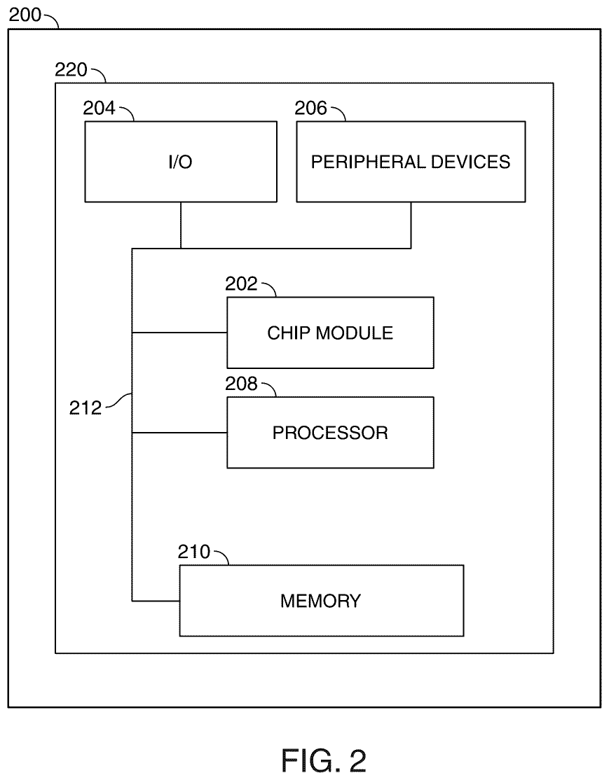

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

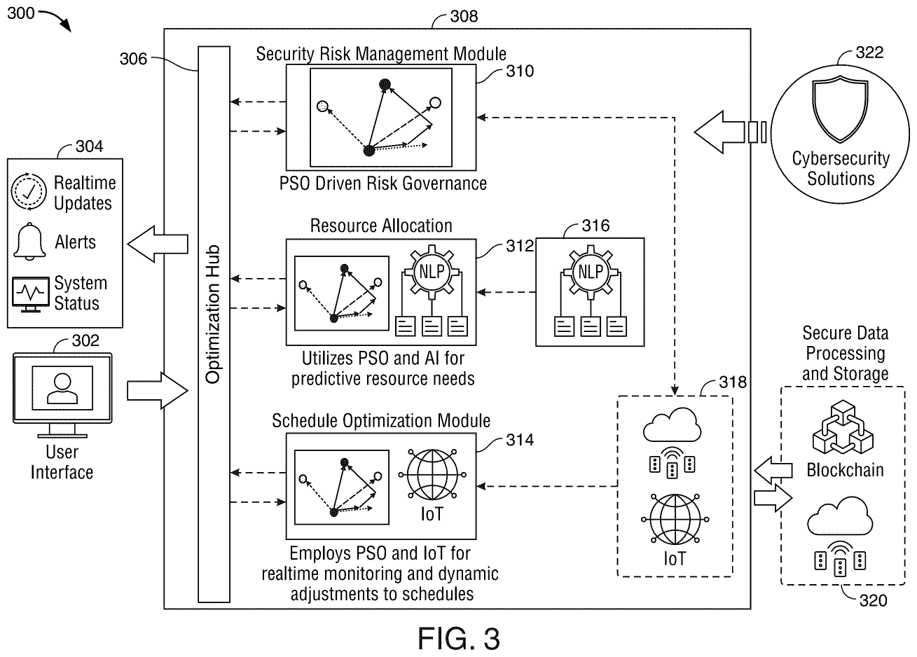

FIG. 3 shows a generalized architecture diagram 300 in accordance with the disclosure. At 302, a user interface is shown. User interface 302 may be used to receive project details. Further, user interface 302 may be used, following receipt of project details, to initiate NPI management.

At 304, the output from generalized architecture diagram 300 is shown. Such output may include real-time updates, alerts and system status.

Both user interface 302 and output 304 may be communicated through optimization hub 306. Optimization hub 306 may preferably instantiate as an I/O device or other suitable device for receiving communication from a user interface 304 and/or providing output 304 to a user.

At 308, a central coordination entity is shown that is responsible for orchestrating communication and collaboration among various modules. At 310, a security management module is shown. Module 310 receives project requirements and historical data to identify potential security risks. Implementing a PSO-driven security risk governance framework enables proactive identification, assessment, and mitigation of security risks throughout the NPI process. PSO dynamically optimizes risk management parameters to minimize potential threats and ensure compliance.

In addition, this module 310 typically electronically communicates security risk mitigation strategies and contingency plans to optimization hub 306. Optimization hub 306 may be configured for use with application programming interface (API)-based communication, with Kafka-based communication or with any other suitable software or hardware based communication platform.

Resource allocation module 312 receives project resource requirements from optimization hub 306. Integrating PSO with AI facilitates predictive resource needs analysis, enabling optimal allocation of resources to minimize bottlenecks and maximize efficiency during NPI. PSO dynamically adjusts resource allocation parameters based on real-time data and predictive analytics.

Natural language processor at 316 (shown as exploded, but which may be understood to form a part of resource allocation module 312) may help in predicting resource needs and dynamically allocating resources.

Resource allocation module 312 may utilize PSO and AI for predicting resource needs. For the purposes of this application, PSO may be understood to include the following design elements and components:

At 318, real-time data derived from the IoT and edge computing resources may be used to provide real-time updates on potential security risks. Such updates may be provided, for example, to security risk management module 310 and schedule optimization module 314.
Particles: Particles represent potential solutions within the solution space.

Each particle corresponds to a potential project plan, or potential solution, in NPI management, with specific parameter values representing different aspects. Such aspects may include resource allocation, task schedules, and security risk mitigation strategies.
Fitness Function: The fitness function evaluates the quality of a particle's solution.

In NPI management, the fitness function assesses how well a particular project plan meets predefined objectives and constraints. This includes factors like budget adherence, schedule efficiency, and risk mitigation effectiveness.
Velocity and Position: Particles have velocities and positions in the solution space.

Velocity represents how a solution is changing, while position reflects the current state. These parameters are updated iteratively to guide the particles toward preferably optimal solutions, while mirroring the adjustment of project plans in response to dynamic project conditions.
Global Best and Personal Best: Global best (Gbest) is the best determined solution among all particles, and personal best is the best solution a particle has experienced.

Global best preferably guides all particles toward the overall optimal solution, while personal best helps each particle recall and/or remember its individual best-performing state. This type of method—i.e., that incorporates global best and personal best—facilitates exploration of the solution space.
Inertia Weight: Inertia weight balances solution exploration and implementation as part of a solution optimization algorithm.

In NPI management, inertia weight determines how much a particle's previous velocity influences its new velocity. A higher inertia weight favors exploration, while a lower one emphasizes implementation, preferably extrapolating to find the best solutions where the extrapolation is based on the current state.

Component process steps for use according to the embodiments may include the following:
Initialization: Initializes the particles with random values within the solution space, representing various project plan configurations.
Evaluation: Evaluates the fitness of each particle based on the defined fitness function, assessing how well the corresponding project plan aligns with NPI management goals.
Update Velocity and Position: May adjust the velocity and position of each particle based on its personal best, global best, and inertia weight. This mimics the continuous refinement of project plans in response to changing project dynamics.
Termination Criteria: Defines conditions for terminating the optimization process, such as reaching a certain number of iterations or achieving a satisfactory fitness level. The termination criteria preferably ensure the algorithm stops when an acceptable solution is found. It should be noted that termination criteria may leverage a machine language command in order to implement termination during an algorithmic implementation of an optimization cycle.

Schedule optimization module is shown at 314. It may receive project schedule and progress from optimization hub 314. It preferably employs PSO and IoT 318 to provide real-time monitoring and dynamic adjustments to NPI schedules. IoT 318 may preferably provide real-time data on migration progress to schedule optimization module 314 and real-time updates on potential security risks to security management module 310. More particularly, schedule optimization module 314 may employ PSO and IoT for real-time monitoring and dynamically adjusting schedules throughout the duration of the NPI.

Cybersecurity solutions 322 may be leveraged to monitor and provide feedback to mitigate security risks throughout the NPI process. Secure data processing and storage is shown as implemented in the blockchain at 320.

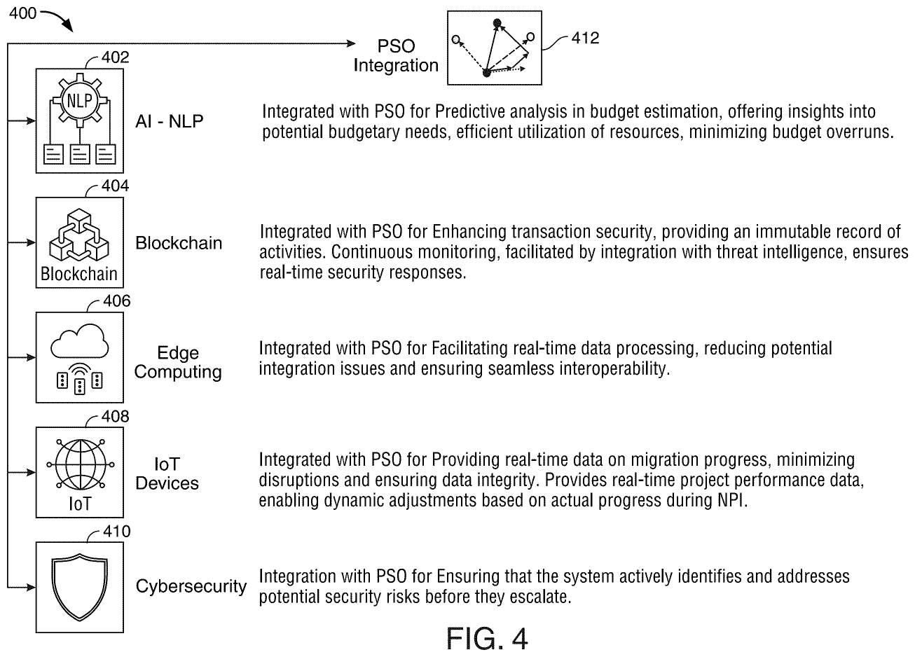

FIG. 4 shows PSO integrations. Such integrations include AI-NLP integrations 402, blockchain integrations 404, edge computing integrations 406, IoT device integrations 408 and cybersecurity integrations 410.

AI-NLP integrations 402 AI-NLP integrations 402, blockchain integrations 404, edge computing integrations 406, IoT device integrations 408 and cybersecurity integrations 410.

Blockchain integrations 404 may be integrated with PSO for enhancing transaction security, while providing a substantially immutable record of activities. Continuous monitoring, facilitated by integration with threat intelligence, ensures real-time security responses.

Edge computing integrations 406 may be integrated with PSO for enhancing transaction security.

IoT device integrations 408 may be integrated with PSO for providing real-time data on migration progress, minimizing disruptions and ensuring data integrity. IoT device integrations 408 may further provides real-time project performance data, thereby enabling dynamic adjustments based on actual progress during NPI.

Cybersecurity integrations 410 may be integrated with PSO for ensuring that the system actively identifies and addresses potential security risks before these security risks escalate.

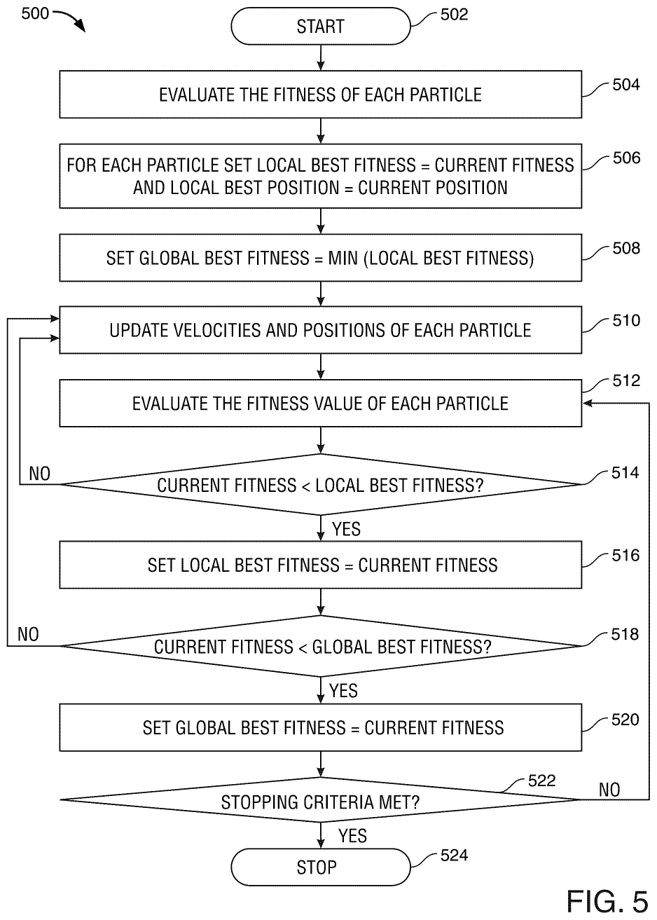

FIG. 5 shows an illustrative flow diagram of technical aspects of embodiments according to the disclosure. More specifically, FIG. 5 shows an illustrative flow describing use of PSO for the various modules set forth in the preceding FIGS. 3 and 4.

The exemplary PSO process starts at 502. At 504, the process may evaluate, for each individual module, the fitness of each particle (solution).

At 506, additional steps of the process may include evaluating the local best fitness—i.e., the current fitness—and the local best position—i.e., the current position.

At 508, the process sets the global best fitness to the min value which corresponds to the local best fitness.

At 510, the process updates velocities and positions of each particle. Thereafter, the process, at 512, evaluates the fitness value of each particle (solution). If the current fitness for each particle is less than the local best fitness, as queried at step 514, then the local best fitness is set to the current fitness, as shown at step 516. If the current fitness for each particle is not less than the local best fitness, then the process may return to step 510, at which the velocities are again updated as are the positions of each particle.

If the current fitness is less than the global best fitness, as queried at 518, then the global best fitness is set to the current fitness. If the current fitness is not less than the global best fitness, then the process returns to step 510, at which the velocities are again updated as are the positions of each particle.

At 522, the process preferably queries as to whether stopping criteria are met. If stopping criteria are met, then, at 524, the process stops evaluating the fitness of each preferably proposed particle. As mentioned above, in certain embodiments, the stopping criteria may leverage a machine language command.

The foregoing exemplary algorithm shown in FIG. 5 is but one example of an algorithm according to the embodiments to determine and/or maintain the optimal level of fitness of particles (solutions). It should be noted that other algorithm's for determining and/or maintaining the optimal level of fitness of the particles are within the scope of the current application, and are considered herein.

Thus, methods and apparatus for providing a dynamic optimization framework for preferably seamless NPI management leveraging particle swarm optimization. Persons skilled in the art will appreciate that the present invention can be practiced by other than the described embodiments, which are presented for purposes of illustration rather than of limitation, and that the present invention is limited only by the claims that follow.

What is claimed is:

1. A system comprising one or more non-transitory computer-readable media storing computer-executable instructions which, when executed by a processor on a computer system, provides new product integration management by leveraging particle swarm optimization (PSO), said new product integration management related to a new product relating to document processing, said system comprising:
an optimization hub for controlling communication within the system;
a resource allocation module for utilizing the PSO and artificial intelligence (AI) for predictive resource needs:
a processor for initializing a plurality of particles with random combinations of artificial intelligence (AI) model settings, each of the plurality of particles representing a solution to a dynamic optimization problem, said dynamic optimization problem addressing finding a current optimal particle for the AI model settings;
wherein the processor is operable, to evaluate a fitness function for each of the particles, in response to receiving information from the optimization hub, the fitness function being based on a document processing speed;
wherein the processor is operable to update a Pbest (Particle/local best) for a first particle when the document processing speed is increased by adjusting, at the resource allocation module via the optimization hub, an AI learning rate for the first particle;
wherein the processor is operable to update a Gbest (Global best) for a second particle when the document processing speed is increased; and
following the updating of the Pbest and Gbest, the processor is further operable to refine the AI model settings based on the updated Pbest and updated Gbest.

2. The system of claim 1, wherein each of the random combinations of AI settings includes a fraud detection threshold.

3. The system of claim 1, wherein each of the random combinations of AI settings includes a document compliance strategy.

4. The system of claim 1, wherein each of the random combinations of AI setting includes a blockchain consensus mechanism.

5. The system of claim 1, wherein the Gbest of the second particle is increased by adjusting an AI learning rate.

6. The system of claim 1, wherein the processor is operable, following a pre-determined number of iterations, to converge, at a predetermined velocity, the random combinations of AI settings to an optimal setting when all of the following conditions are met: the document processing time is reduced from an initial setting, a fraud detection accuracy is increased from an initial setting, and a compliance score meets pre-determined regulatory standards.

7. A system comprising one or more non-transitory computer-readable media storing computer-executable instructions which, when executed by a processor on a computer system, provides new product integration management by leveraging particle swarm optimization (PSO), said new product integration management related to a new product relating to document processing, said system comprising:
a processor for initializing a plurality of particles with random combinations of artificial intelligence (AI) model settings, each of the plurality of particles representing a solution to a dynamic optimization problem, said dynamic optimization problem addressing finding a current optimal particle for the AI model settings;
wherein the processor is used for evaluating a fitness function for each of the particles, the fitness function being based on a document processing speed;
wherein the processor is operable to update a Pbest (Particle/local best) for a first particle when the document processing speed for the first particle is increased;
wherein the processor is operable to update a Gbest (Global best) for a second particle when a document fraud detection accuracy threshold is increased; and
following the updating of the Pbest and Gbest, the processor is further operable to refine the AI model settings based on the updated Pbest and updated Gbest.

8. The system of claim 7, wherein each of the random combinations of AI settings includes a fraud detection threshold.

9. The system of claim 7, wherein each of the random combinations of AI settings includes a document compliance strategy.

10. The system of claim 7, wherein each of the random combinations of AI setting includes a blockchain consensus mechanism.

11. The system of claim 7, wherein the Gbest of the second particle is increased by adjusting an AI learning rate.

12. The system of claim 7, wherein the processor is operable, following a pre-determined number of iterations, to converge to an optimal setting where the document processing time is reduced, if not minimized, a fraud detection accuracy is increased, if not maximized, and a compliance score meets pre-determined regulatory standards.

13. A method for execution by a processor on a computer system, the method for providing new product integration management by leveraging particle swarm optimization (PSO), said new product integration management related to a new product relating to document processing, said method comprising:
initializing, using a processor, a plurality of particles with random combinations of artificial intelligence (AI) model settings, each of the plurality of particles representing a solution to a dynamic optimization problem, said dynamic optimization problem addressing finding a current optimal particle for the AI model settings;
evaluating, by the processor, a fitness function for each of the particles, the fitness function being based on a document processing speed;
updating, by the processor, a Pbest (Particle/local best) for a first particle when the document processing speed for the first particle is increased;
updating, by the processor, a Gbest (Global best) for a second particle when the document processing speed is increased; ; and
following the updating of the Pbest and Gbest, refining the AI model settings based on the updating the Pbest and the updating the Gbest.

14. The method of claim 13, wherein each of the random combinations of AI settings includes a fraud detection threshold.

15. The method of claim 13, wherein each of the random combinations of AI settings includes a document compliance strategy.

16. The method of claim 13, wherein each of the random combinations of AI setting includes a blockchain consensus mechanism.

17. The method of claim 13, wherein the Gbest of the second particle is increased by adjusting an AI learning rate.

18. The method of claim 13 further comprising, following a pre-determined number of iterations, converging the solution to obtain the optimal solution, where the document processing time is reduced, a fraud detection accuracy is increased, and a compliance score meets pre-determined regulatory standards.
